(19) United States
(12) Patent Application Publication
(10) Pub. No.: US 2025/0083708 A1
(43) Pub. Date: Mar. 13, 2025

(54) AUTOMATED PICKUP AND DROP OFF PLANNING AND EXECUTION FOR VEHICLES

(71) Applicant: GM Global Technology Operations LLC, Detroit, MI (US)

(72) Inventors: Alireza Esna Ashari Esfahani, San Bruno, CA (US); Prabhjot Kaur, Auburn Hills, MI (US)

(21) Appl. No.: 18/464,702

(22) Filed: Sep. 11, 2023

(51) Int. Cl. B60W 60/00; G06Q 50/30

(52) U.S. Cl. CPC B60W 60/00253; G06Q 50/40; B60W 2540/00

(57) ABSTRACT

A method for automated pickup and drop-off planning and execution includes receiving people-transfer data. The people-transfer data includes passenger data and a destination data. The method also includes detecting a plurality of restricted locations along the infrastructure using the destination data. The method also includes determining a transfer location based on the plurality of restricted locations and the passenger data. The transfer location is a position where the passenger will transfer between the vehicle and the pedestrian location outside the vehicle. The method also includes commanding the vehicle to move toward the transfer location; and commanding the vehicle to stop once the vehicle reaches the transfer location.

### INTRODUCTION

The present disclosure relates to a vehicle system and method for automated pickup and drop-off planning and execution.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Some vehicle sometimes carry passenger that need to be picked up or dropped-off adjacent to an infrastructure, such as an airport terminal. In these situations, the vehicles stop momentarily in front of the infrastructure to allow the vehicle passenger to enter or exit the infrastructure. It is therefore desirable to develop a system and method for automated passenger pickup and drop-off planning and execution.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for pickup and drop off planning. The method also includes receiving people-transfer data. The people-transfer data includes passenger data and a destination data. The passenger data includes information about a person that will move between a vehicle and a pedestrian location outside the vehicle, the pedestrian location outside the vehicle is adjacent to an infrastructure. The destination data includes information about the infrastructure and an area directly adjacent to the infrastructure. The method also includes detecting a plurality of restricted locations along the infrastructure using the destination data. Each of the restricted locations is unavailable for the vehicle to stop. The method also includes determining a transfer location based on the plurality of restricted locations and the passenger data. The transfer location is a position where the passenger will transfer between the vehicle and the pedestrian location outside the vehicle. The method includes performing a control action in response to determining the transfer location. The control action may be commanding the vehicle to move toward the transfer location and commanding the vehicle to stop once the vehicle reaches the transfer location. Alternatively, the control action may be to command the user interface to show a transfer location on a map. Other embodiments of this aspect include corresponding computer systems, apparatus, and computer programs recorded on one or more computer storage devices, each configured to perform the actions of the methods.

Implementations may include one or more of the following features. The method may include filtering out the plurality of restricted locations to determine a plurality of available stop segments along the infrastructure. The method may include determining a time required for the passenger to transfer between the vehicle and the pedestrian location outside the vehicle. The optimal transfer point without restrictions is a position that results in a minimum distance from the vehicle to an entrance to the infrastructure. The method may include determining a midpoint of a length for each of the plurality of available stop segments. The method may include determining the midpoint of the length of each of the plurality of available stop segments. The method may include filtering out segments that have a length that is less than a predetermined length threshold to determine a plurality of feasible stop segments. The method may include determining a distance from the midpoint of the length of each of the plurality of feasible stop segments to the optimal transfer point without restrictions to determine a plurality of segment distances. The method may include determining, for each of the plurality of feasible stop segments, a probability that the plurality of feasible stop segments will be available when the vehicle reaches a corresponding one of the plurality of feasible stop segments to determine a plurality of available probabilities. The method may include sorting the plurality of feasible stop segments based on a ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments. The method may include: determining which of the plurality of feasible stop segments has a lowest value ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments to selecting the plurality of feasible stop segments with the lowest value of the ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments to determine a selected feasible stop segment. The selected feasible stop segment is designated as the transfer location, and the method further includes commanding the vehicle to move toward the feasible stop segment. Implementations of the described techniques may include hardware, a method or process, or computer software on a computer-accessible medium.

The present disclosure also describes a vehicle including sensors and a controller in communication with the sensors. The controller is programmed to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a block diagram depicting a vehicle.

FIG. 2 is a block diagram depicting the vehicle 10 of FIG. 1 moving toward a transfer location adjacent to an infrastructure.

FIG. 3 is a flowchart of a method for automated pickup and drop-off planning and execution.

FIG. 4 is a flowchart of a method to estimate the required time for pickup or drop-off.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

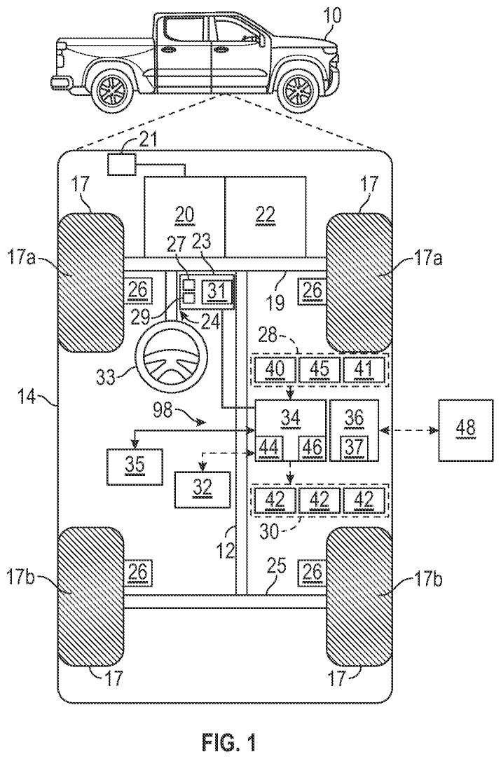

With reference to FIG. 1, a vehicle 10 generally includes a chassis 12, a body 14, front and rear wheels 17 and may be referred to as a vehicle system. In the depicted embodiment, the vehicle 10 includes two front wheels 17a and two rear wheels 17b. The body 14 is arranged on the chassis 12 and substantially encloses components of the vehicle 10. The body 14 and the chassis 12 may jointly form a frame. The wheels 17 are each rotationally coupled to the chassis 12 near a respective corner of the body 14. The vehicle 10 includes a front axle 19 coupled to the front wheels 17a and a rear axle 25 coupled to the rear wheels 17b.

The vehicle 10 may be an autonomous vehicle or a manually-controlled vehicle, and a control system 98 is incorporated into the vehicle 10. The system 98 may be referred to as the system. The vehicle 10 is, for example, a vehicle that is automatically controlled to carry passengers from one location to another. The vehicle 10 is depicted in the illustrated embodiment as a pickup truck, but it should be appreciated that other vehicles including, trucks, sedans, coupes, sport utility vehicles (SUVs), recreational vehicles (RVs), etc., may also be used. In an embodiment, the vehicle 10 may include a so-called a Level Two, a Level Three, Level Four, or Level Five driving automation system. A Level Four system indicates “high automation,” referring to the driving mode-specific performance by an automated driving system of aspects of the dynamic driving task, even if a human driver does not respond appropriately to a request to intervene. A Level Five system indicates “full automation,” referring to the full-time performance by an automated driving system of aspects of the dynamic driving task under a number of roadway and environmental conditions that can be managed by a human driver. In Level 3 vehicles, the system 98 performs the entire dynamic driving task (DDT) within the area that it is designed to do so. In Level 2 vehicles, systems provide steering, brake/acceleration support, lane centering, and adaptive cruise control. However, even if these systems are activated, the vehicle operator at the wheel must be driving and constantly supervising the automated features.

As shown, the vehicle 10 generally includes a propulsion system 20, a transmission system 22, a steering system 24, an Anti-lock Braking System (ABS) 26, a sensor system 28, an actuator system 30, at least one data storage device 32, at least one controller 34, and a communication system 36. The steering system 24 is a steer-by-wire system. The propulsion system 20 may, in various embodiments, include an electric machine such as a traction motor and/or a fuel cell propulsion system. The vehicle 10 may further include a battery (or battery pack) 21 electrically connected to the propulsion system 20. Accordingly, the battery 21 is configured to store electrical energy and to provide electrical energy to the propulsion system 20. In certain embodiments, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously-variable transmission, or other appropriate transmission. The ABS 26 is configured to provide braking torque to the vehicle wheels 17. The ABS 26 may, in various embodiments, include friction brakes, brake by wire, a regenerative braking system such as an electric machine, and/or other appropriate braking systems. The steering system 24 influences the position of the vehicle wheels 17 and may include a steering wheel 33. While depicted as including a steering wheel 33 for illustrative purposes, in some embodiments contemplated within the scope of the present disclosure, the steering system 24 may not include a steering wheel 33.

The sensor system 28 includes one or more sensors 40 (i.e., sensing devices) that sense observable conditions of the exterior environment and/or the interior environment of the vehicle 10. The sensors 40 are in communication with the controller 34 and may include, but are not limited to, one or more steering wheel sensors 45, one or more radars, one or more light detection and ranging (lidar) sensors, one or more proximity sensors, one or more wheel speed sensors, one or more odometers, one or more ground penetrating radar (GPR) sensors, one or more steering angle sensors, Global Navigation Satellite System (GNSS) transceivers (e.g., one or more global positioning systems (GPS) transceivers), one or more tire pressure sensors, one or more throttle position sensors, one or more cameras 41 (e.g., eye tracker), one or more gyroscopes, one or more accelerometers, one or more inclinometers, one or more speed sensors, one or more ultrasonic sensors, one or more inertial measurement units (IMUs), one or more night-vision devices, thermal imaging sensors, and/or other sensors. Each sensor 40 is configured to generate a signal that is indicative of the sensed observable conditions of the exterior environment and/or the interior environment of the vehicle 10. Because the sensor system 28 provides data to the controller 34, the sensor system 28 and its sensors 40 are considered sources of information (or simply sources). The vehicle 10 and/or system 98 does not include light sensors capable of detecting light inside the vehicle 10.

The actuator system 30 includes one or more actuator 42 that control one or more vehicle features such as, but not limited to, the propulsion system 20, the transmission system 22, the steering system 24, and the ABS 26. In various embodiments, the vehicle features may further include interior and/or exterior vehicle features such as, but are not limited to, doors, a trunk, and cabin features such as air, music, lighting, etc. The actuator 42 may include a throttle.

The data storage device 32 stores data for use in automatically controlling the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. The data storage device 32 may be part of the controller 34, separate from the controller 34, or part of the controller 34 and part of a separate system.

The vehicle 10 may further include one or more airbags 35 in communication with the controller 34 or another controller of the vehicle 10. The airbag 35 includes an inflatable bladder and is configured to transition between a stowed configuration and a deployed configuration to cushion the effects of an external force applied to the vehicle 10. The sensors 40 may include an airbag sensor, such as an IMU, configured to detect an external force and generate a signal indicative of the magnitude of such external force. The controller 34 is configured to command the airbag 35 to deploy based on the signal from one or more sensors 40, such as the airbag sensor. Accordingly, the controller 34 is configured to determine when the airbag 35 has been deployed.

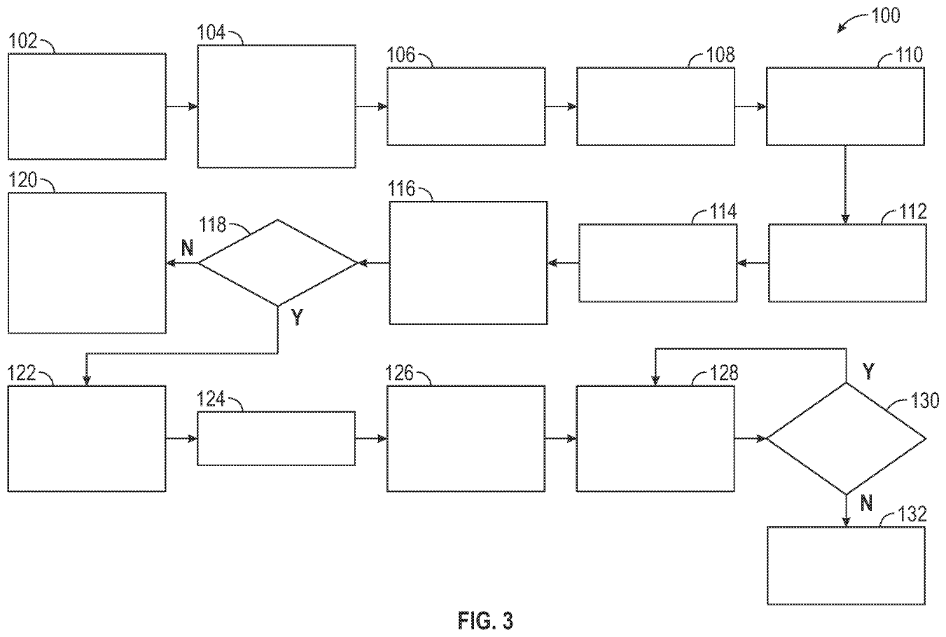

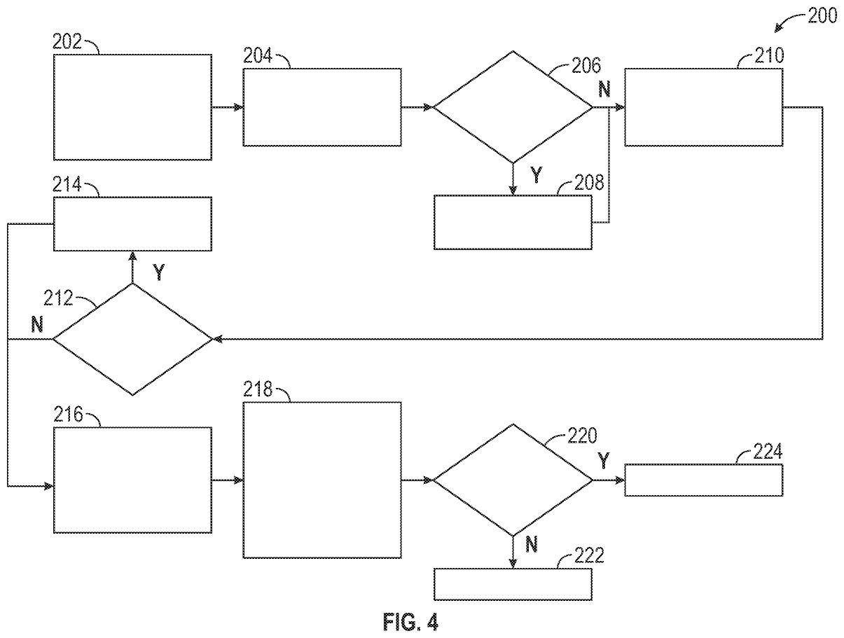

The controller 34 includes at least one processor 44 and a non-transitory computer readable storage device or media 46. The processor 44 may be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10. The controller 34 of the vehicle 10 may be referred to as a vehicle controller and may be programmed to execute methods 100 (FIG. 3) and method 200 (FIG. 4) as described in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a plurality of controllers 34 that communicate over a suitable communication medium or a combination of communication mediums and that cooperate to process the sensor signals, perform logic, calculations, methods, and/or algorithms, and generate control signals to automatically control features of the vehicle 10. In various embodiments, one or more instructions of the controller 34 are embodied in the control system 98.

The vehicle 10 includes a user interface 23, which may be a touchscreen in the dashboard. The user interface 23 may include, but is not limited to, an alarm, such as one or more speakers 27 to provide an audible sound, haptic feedback in a vehicle seat or other object, one or more displays 29, one or more microphones 31 and/or other devices suitable to provide a notification to the vehicle user of the vehicle 10. The user interface 23 is in electronic communication with the controller 34 and is configured to receive inputs by a vehicle occupant 11 (e.g., a vehicle driver or a vehicle passenger). For example, the user interface 23 may include a touch screen and/or buttons configured to receive inputs from a vehicle occupant 11. Accordingly, the controller 34 is configured to receive inputs from the user via the user interface 23. The vehicle 10 may include one or more displays 29 configured to display information to the vehicle occupant 11 (e.g., vehicle operator or passenger) and may be a head-up display (HUD).

The communication system 36 is in communication with the controller 34 and is configured to wirelessly communicate information to and from other remote vehicles 48, such as but not limited to, other vehicles (“V2V” communication), infrastructure (“V2I” communication), remote systems at a remote call center (e.g., ON-STAR by GENERAL MOTORS) and/or personal electronic devices, such as a mobile phone. In the present disclosure, the term “remote vehicle” means a vehicle, such as a car, configured to transmit one or more signals to the vehicle 10 while not physically connected to the vehicle 10. In certain embodiments, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. Accordingly, the communication system 36 may include one or more antennas and/or communication transceivers 37 for receiving and/or transmitting signals, such as cooperative sensing messages (CSMs). The communication transceivers 37 may be considered sensors 40. The communication system 36 is configured to wirelessly communicate information between the vehicle 10 and another vehicle. Further, the communication system 36 is configured to wirelessly communicate information between the vehicle 10 and infrastructure or other vehicles.

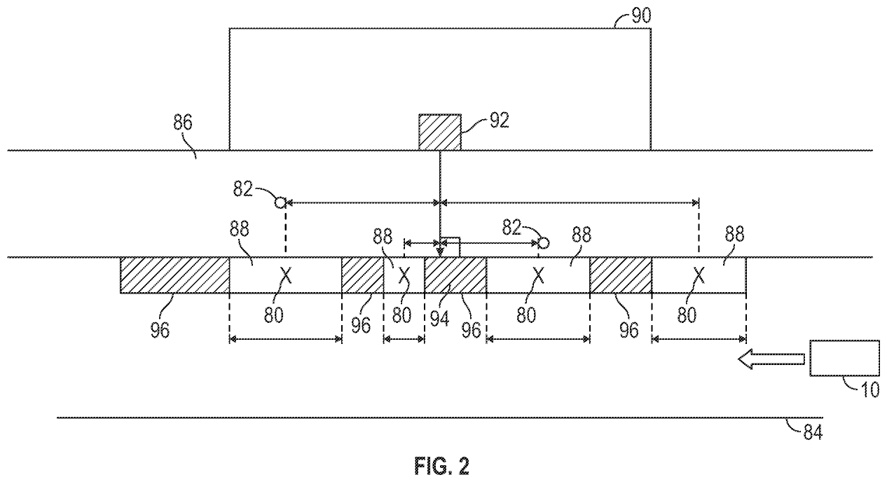

With reference to FIG. 2, the system 98 of the vehicle 10 is configured to automated pickup and drop-off planning and execution. The system 98 gathers the passengers' preferences and needs, recognizes spots available pickup or drop-off directly adjacent to an infrastructure 90 (e.g., building), selects the best available spot using an optimization approach and commands the vehicle 10 to execute the maneuver to move toward the best available spot. The infrastructure 90 typically includes an entryway 92 (e.g., stairs, doors, etc.). Ideally, the vehicle 10 stops at a location directly in front of the entryway 92 of the infrastructure 90 (i.e., the optimal transfer point 94 designated with a star). However, the optimal transfer point 94 is not always available. The spots along the infrastructure 90 that are not available are referred to as restricted locations 96. As non-limiting examples, the restricted locations 96 are not available for the vehicle 10 to stop because of regulations (i.e., not stopping sign), a pedestrian is occupying that location, another vehicle is occupying that location, the location is in front of a driveway, etc. The system 98 therefore applies a pickup/drop off optimization algorithm to recognize the best location for drop off and/or pickup passengers based on the distance to the nearest location to destination (e.g., the optimal transfer point 94 designated with a star) and the length of free spots. The system 98 also determines the probability that the spot will be available when the vehicle 10 arrives at that spot.

At the outset, the system 98 collects passenger requirements for drop off and pickup (i.e., people-transfer data), and predicts the time needed for pickup and drop off. Special conditions include carrying heavy items, accompanying kids, handicaps, need for opening trunk, weather conditions. Then, the system 98 recognizes the nearest location to the destination based on the situation. The destination may be the entrance door of an infrastructure, a handicap ramp or the stairs. The system 98 then estimates how much time may be required for drop off and pickup. This time estimation is based on the special assistance a customer may need (e.g., handicap, sick) or items customer need to load or unload. Next, the system 98 finds all the free spots for drop-off and pickup (i.e., the available stop segments 88) on a strip near the destination (e.g., entryway 92 of the infrastructure 90). The system 98 considers traffic signs, fire hydrant, driveways, and all restrictions that should be considered to make a stop. The system 98 verifies if the available spots (i.e., the available stop segments 88) for drop off or pickup has stopping time limits that are less than the estimated drop-off or pickup time. Further, the system 98 evaluates if a stop is legal based on estimated drop off and pickup time in the recognized free spot. Further, the system 98 computes the probability of the stop segments 88 being available once the vehicle 10 arrives at the stop segment 88. The system 98 can communicate with passengers to set up a location for drop-off and pickup in highly crowded locations, such as concerts, stadiums, shopping malls, etc.

With reference to FIGS. 2 and 3, a flowchart for a method 100 for automated pickup and drop-off planning and execution is shown in FIG. 3 and is discussed with reference to FIG. 3. The method 100 begins at block 102. At block 102, the controller 34 receives people-transfer data including passenger data. The passenger data includes information about a person that will move between the vehicle 10 and a pedestrian location 82 outside the vehicle 10 near the destination. The pedestrian location 82 may be on sidewalk 86 between the infrastructure 90 and a roadway 84. The vehicle 10 is moving along the roadway 84. In other words, the controller 34 collects all passenger requirements (i.e., the passenger data). As non-limiting examples, the passenger requirements may include information about any passenger handicap, whether the passenger is carrying heavy items, whether the passenger is carrying one or more minors (e.g., infants), etc. The passenger data may also include information identifying the user (i.e., future passenger) of pickup scenarios. For example, face recognition may be used to identify the user that has to be picked up. The passenger data may also include other identifying information about the person or party that will be picked up by the vehicle 10. Then, the method 100 continues to block 104.

At block 104, the controller 34 receives destination data, which includes information about the infrastructure 90 and the area directly adjacent to the infrastructure 90. Using the destination data, the controller 34 detects all the restrictions along the infrastructure 90 and therefore detects the restriction locations 96 along the infrastructure 90. As non-limiting examples, the restrictions may be due to driveways, prohibited locations by signs, locations in front of fire hydrants, etc. The sensor system 28 (e.g., cameras 41) may be used to find objects that indicate stopping restrictions, such as fire hydrants, driveways, pedestrians, etc. Further, the sensor system 28 may use sign recognition to read time limits as well as other restrictions along available stop segments 88 adjacent to the infrastructure 90. The sensor system 28 may use gesture recognition to interpret parking-related gesture by law enforcement personnel. Using the destination data, the controller 34 identifies and locates the restricted locations 96 adjacent to the infrastructure 90. As discussed above, the restricted locations 96 are not available for the vehicle 10 to stop. The method 100 then continues to block 106.

At block 106, the controller 34 filters out the restricted locations 96 to identify the available stop segments 88 along the infrastructure 90. Then, the method 100 proceeds to block 108. Further, block 106 entails identifying the boundaries of the feasible stop segments 88 using the data about the restricted locations 96. At block 108, the controller 34 uses the passenger data to determine the time required for the passenger to transfer between the vehicle 10 and the pedestrian location 82 outside the vehicle 10. In other words, the controller 34 determines the time required for the passenger to be picked up or dropped-off based on the passenger requirements. The method 100 then continuous to block 110.

At block 110, the controller 34 determines (e.g., computes) an optimal transfer point 94 without restrictions. The optimal transfer point 94 without restrictions is a position that results in a minimum distance from the vehicle 10 to the entryway 92 (e.g., door, stairs, handicap ramp, etc.) to the infrastructure 90, the passenger location, or the location specified by the user for pickup and/or drop-off. As a non-limiting example, the optimal transfer point 94 may be a determined by drawing a straight line from the entryway 92 of the infrastructure 90 orthogonal to a segment of the roadway 84 that is adjacent to the infrastructure 90. As discussed above, the optimal transfer point 94 without restrictions is identified with a star. Then, the method 100 continues to block 112.

At block 112, using the previously determined boundaries of the available stop segments 88, the controller 34 determines (e.g., computes) a midpoint 80 of a length Li of each of the available stop segments 88. The i in Li ranges between 1 and N, where N is the number of available stop segments 88 detected by the system 98. The midpoints 80 are identified with an X. At block 114, using the previously determined boundaries of the available stop segments 88, the controller 34 determines (e.g., computes) the length Li of each of the available stop segments 88. It is envisioned that the controller 34 may execute block 114 before or after executing block 112. Then, the method 100 continues to block 116.

At block 116, the controller 34 compares the length Li of each of the available stop segments 88 with a predetermined length threshold to determine which of the available stop segments 88 has a length Li that is less than the predetermined length threshold. The predetermined length threshold is equal to the length of the vehicle 10 plus a predetermined additional length for maneuverability. The controller 34 then filters out the available stop segments 88 segments that have a length that is less than the predetermined length threshold to determine a plurality of feasible stop segments (if any). The method 100 then proceeds to block 118.

At block 118, the controller 34 determines if there are any feasible stop segments. If there are no feasible stop segments 88, then the method 100 continues to block 120. At block 120, the controller 34 commands the vehicle 10 autonomously move forward and look for other available locations. Alternatively, the controller 34 commands the vehicle 10 to stop or slow down for available feasible stop segments. If there are one or more feasible stop segments, then the method 100 continues to block 122. At block 122, the controller 34 determines the distance Di from the midpoint 80 of the length Li of each of the feasible stop segments 88 to the optimal transfer point 94 without restrictions. These distances Di may be referred to as segment distances Di. The i in the term Di ranges between 1 and N, where N is the number of available stop segments 88 detected by the system 98. The method 100 then continues to block 124.

At block 124, for each feasible stop segment 88, the controller 34 determines the probability Pi that the feasible stop segments 88 will be available when the vehicle 10 reaches the feasible stop segment 88. To do so, the controller 34 uses a predictor, such as a neural network. The predictor (e.g., neural network) uses several inputs, such as the vehicle speed, the vehicle location, the vehicle heading angle, the vehicle speed, the location, speed, and heading of all other actors (e.g., other vehicles and pedestrians), the location of the midpoint 80 of the feasible stop segment 88, and whether other vehicles have their left turn signal turned on, the right turn signal turned on, and/or the backup lights of other vehicles are turned on. Next, the method 100 continues to block 126.

At block 126, the controller 34 sorts (ascendingly) the feasible stop segments 88 using a ratio (Di/Pi) between the distance Di from the midpoint 80 of the length Li of each of the feasible stop segments 88 to the optimal transfer point 94 without restrictions with respect to the probability Pi that the feasible stop segments 88 will be available when the vehicle reaches that particular feasible stop segment 88. The method 100 then proceeds to block 128.

At block 128, the controller 34 selects the feasible stop segment 88 with the lowest value of the ratio (Di/Pi) between the distance Di from the midpoint 80 of the length Li of each of the feasible stop segments 88 to the optimal transfer point 94 without restrictions with respect to the probability Pi that the feasible stop segments 88 will be available when the vehicle reaches that particular feasible stop segment 88. Then, the method 100 continues to block 130.

At block 130, the controller 34 determines whether the user (i.e., the person that will be picked or dropped off objects to the selected feasible stop segment 88. The customer may input the objection to the selected feasible stop segment 88, through, for example, a mobile electronic device or the user interface 23 of the vehicle 10. If the user objects to the selected feasible stop segment 88, then the method 100 returns to block 128. At block 128, the controller 34 selects the next feasible stop segment 88 on the sorted list. If the user does not object to the selected feasible stop segment 88, then the method 100 continues to block 132. At block 132, the controller commands the user interface 23 to highlight the selected stop segment 88 on a map to assist driver to drive and park in the selected spot. Alternatively, the controller 34 commands the vehicle 10 to move autonomously to the selected feasible stop segment 88. Further, the controller 34 commands the vehicle 10 to autonomously stop once the vehicle 10 reaches the selected feasible stop segment 88.

FIG. 4 is a method 200 for estimating the required time for pickup or drop-off as discussed above with respect to block 108. The method 200 begins at block 202. Block 202 entails asking the user how much time he or she requires for pickup or drop-off. Then, the method 200 continues to block 204. Block 204 entails optionally asking the user about the items they carry (e.g., quantity, weight, size, etc.). The user has a choice to enter those details (i.e., the items they carry) or skip this step. Then, the method 100 continues to block 206. Block 206 entails determining if the user is carrying any items based on the response in block 204. If the user is carrying items, then the method 200 proceeds to block 208. At block 208, the controller 34 adds a predetermined time value to time requested by the user (if needed). If the user is not carrying items, then the method 200 continues to block 210. The method 200 also continues to block 210 after executing block 208. Block 210 entails asking the user if they need special assistance (e.g., handicap or sick) that may require extra time for pick up or drop-off. The user has a choice to enter the information or skip this step if they don't need such assistance. Then, the method 200 continues to block 212. At block 212, the controller 34 determines whether the user needs special assistance. If the user needs special assistance, then the method 200 continues to block 214. Block 214 entails adding a predetermined time value to time requested by the user (if needed). Then, the method 200 continues to block 216. The method 200 also continues to block 216 after executing block 212. At block 216, the controller 34 uses the sensor data from the sensors 40 to detect and identify the objects being carried by the user. Then, the method 200 continues to block 218. At block 218, the controller 34 queries a database for the average time it takes to load or upload carried items to the vehicle 10. Then, the method 200 continues to block 220. At block 220, the controller 34 determine whether the information about average time it takes to load or upload the carried items to the vehicle 10, wherein such information was retrieved from a database. If the information about average time it takes to load or upload the carried items to the vehicle 10 is not found, then the method 200 continues to block 222. At block 222, no update is made to the estimation of the time required for pick up or drop-off. If the information about average time it takes to load or upload the carried items to the vehicle 10 is found, then the method 200 continues to block 224. At block 224, the controller 34 makes a judgment about the estimation of the time based on the average time it takes to load or upload the items carried by the user to the vehicle 10 and updates the time requested by the user in block 202, if necessary.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for pickup and drop off planning, comprising:
receiving people-transfer data, wherein the people-transfer data includes passenger data and a destination data, the passenger data includes information about a person that will move between a vehicle and a pedestrian location outside the vehicle, the pedestrian location outside the vehicle is adjacent to an infrastructure, and the destination data includes information about the infrastructure and an area directly adjacent to the infrastructure;
detecting a plurality of restricted locations along the infrastructure using the destination data, wherein each of the plurality of restricted locations is unavailable for the vehicle to stop;
determining a transfer location based on the plurality of restricted locations and the passenger data, wherein the transfer location is a position where the passenger will transfer between the vehicle and the pedestrian location outside the vehicle; and
commanding the vehicle to perform a control action in response to determining the transfer location.

2. The method of claim 1, further comprising filtering out the plurality of restricted locations to determine a plurality of available stop segments along the infrastructure, wherein the control action is to command a user interface of the vehicle to show the transfer location on a map.

3. The method of claim 2, further comprising determining a time required for the passenger to transfer between the vehicle and the pedestrian location outside the vehicle.

4. The method of claim 3, further comprising determining an optimal transfer point without restrictions.

5. The method of claim 4, further comprising determining a midpoint of a length of each of the plurality of available stop segments.

6. The method of claim 5, further comprising determining a length of each of the plurality of available stop segments.

7. The method of claim 6, further comprising filtering out segments that have a length that is less than a predetermined length threshold to determine a plurality of feasible stop segments.

8. The method of claim 7, further comprising determining a distance from the midpoint of the length of each of the plurality of feasible stop segments to the optimal transfer point without restrictions to determine a plurality of segment distances.

9. The method of claim 8, further comprising determining, for each of the plurality of feasible stop segments, a probability that the plurality of feasible stop segments will be available when the vehicle reaches a corresponding one of the plurality of feasible stop segments to determine a plurality of available probabilities.

10. The method of claim 9, further comprising sorting the plurality of feasible stop segments based on a ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments.

11. The method of claim 10, further comprising:
determining which of the plurality of feasible stop segments has a lowest value ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments to
selecting the plurality of feasible stop segments with the lowest value of the ratio between the distance from the midpoint of the length of each of the plurality of feasible stop segments to the optimal transfer point without restrictions with respect to the probability that the plurality of feasible stop segments will be available when the vehicle reaches a corresponding one of the plurality of feasible stop segments to determine a selected feasible stop segment.

12. The method of claim 11, wherein the selected feasible stop segment is designated as the transfer location, and the method further includes commanding the vehicle to move toward the feasible stop segment.

13. A vehicle, comprising:
a plurality of sensors;
a controller including a processor and a tangible, non-transitory, machine-readable medium, wherein the controller is in communication with the a plurality of sensors, and the controller is programmed to:
receive people-transfer data, wherein the people-transfer data includes passenger data and a destination data, the passenger data includes information about a person that will move between a vehicle and a pedestrian location outside the vehicle, the pedestrian location outside the vehicle is adjacent to an infrastructure, and the destination data includes information about the infrastructure and an area directly adjacent to the infrastructure;
detect a plurality of restricted locations along the infrastructure using the destination data, wherein each of the plurality of restricted locations is unavailable for the vehicle to stop;
determine a transfer location based on the plurality of restricted locations and the passenger data, wherein the transfer location is a position where the passenger will transfer between the vehicle and the pedestrian location outside the vehicle; and
command the vehicle to perform a control action in response to determining the transfer location.

14. The vehicle of claim 13, wherein the controller is programmed to filter out the plurality of restricted locations to determine a plurality of available stop segments along the infrastructure, wherein the control action includes:
commanding the vehicle to autonomously move the transfer location; and
commanding the vehicle to autonomously stop when the vehicle reaches the transfer location.

15. The vehicle of claim 14, wherein the controller is programmed to determine a time required for the passenger to transfer between the vehicle and the pedestrian location outside the vehicle.

16. The vehicle of claim 15, wherein the controller is programmed to determine an optimal transfer point without restrictions.

17. The vehicle of claim 16, wherein the controller is programmed to determine a midpoint of a length of each of the plurality of available stop segments.

18. The vehicle of claim 17, wherein the controller is programmed to determine a length of each of the plurality of available stop segments.

19. The vehicle of claim 18, wherein the controller is programmed to filter out segments that have a length that is less than a predetermined length threshold to determine a plurality of feasible stop segments.

20. The vehicle of claim 19, wherein the controller is programmed to determine a distance from the midpoint of the length of each of the plurality of feasible stop segments to the optimal transfer point without restrictions to determine a plurality of segment distances.
